(19) United States
(12) Patent Application Publication
(10) Pub. No.: US 2009/0226676 A1
(43) Pub. Date: Sep. 10, 2009

(54) MOLDED ARTICLE WITH IN-MOLDED DECORATIVE ELEMENT

(75) Inventors: Nels R. Smith, Zeeland, MI (US); Scott A. Hansen, Holland, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 12/158,295

(22) PCT Filed: Dec. 18, 2006
(86) PCT No.: PCT/US06/48007

§ 371 Date: Oct. 16, 2008

Related U.S. Application Data
(60) Provisional application No. 60/752,834, filed on Dec. 22, 2005.

(51) Int. Cl. B32B 3/00; B32B 27/32; B29C 65/00

(52) U.S. Cl. 428/195.1; 428/523; 264/132; 264/241

(57) ABSTRACT

A molded article, such as a door trim panel, for a vehicle interior comprises a coverstock configured to provide at least a portion of an A-side of the molded article; a decorative element coupled to the coverstock by an adhesive; and a substrate molded behind the coverstock and configured to provide structural support to the coverstock. The decorative element may be an injection molded plastic material. The adhesive may comprise a pressure sensitive adhesive. The coverstock and substrate may comprise a recess for the decorative element to be located at least partially within.

### CROSS-REFERENCE TO RELATED PATENT APPLICATIONS

This Application claims the benefit of U.S. Provisional Application No. 60/752,834, filed Dec. 22, 2005, the content of which is incorporated herein by reference in its entirety.

### BACKGROUND

The present application relates generally to the field of molded articles or components having a substrate, a coverstock, and a decorative element coupled to the coverstock. More particularly, the present invention relates to vehicle trim panels that include a molded substrate, a coverstock, and a decorative element coupled to the coverstock with a pressure sensitive adhesive.

It is generally known to provide a laminated panel that includes a cover layer bonded to a rigid substrate that has been softened by heat. Such known cover layers comprise decorative elements that are attached by a projection extending from the decorative element through a hole in the substrate and then held in place by heat staking or a fastener. However, such known methods require additional labor and/or fixturing during assembling, may incur craftsmanship issues (e.g., gaps between the decorative element and the trim panel, noise during consumer use, etc.), or be susceptible to breakage.

Accordingly, it would be advantageous to provide a molded article having a coverstock with one or more decorative elements coupled to the coverstock by a pressure sensitive adhesive. It would also be advantageous to provide a trim panel with the decorative element located within a recess formed in the coverstock and/or substrate. To provide an inexpensive, reliable, and widely adaptable in-molded decorative element that avoids the above-referenced and other problems would represent a significant advance in the art.

### SUMMARY

According to one embodiment, the invention is directed to a molded article, such as a door trim panel, for a vehicle interior comprising a coverstock configured to provide at least a portion of an A-side of the molded article; a decorative element coupled to the coverstock by an adhesive; and a substrate molded behind the coverstock and configured to provide structural support to the coverstock. The decorative element may be injection molded. The adhesive may comprise a pressure sensitive adhesive. The coverstock and substrate may comprise a recess for the decorative element to be located at least partially within.

According to another embodiment, the invention is directed to a method of making a molded article for a vehicle interior comprising providing a coverstock and a decorative element; applying the decorative element to the coverstock with an adhesive; positioning the coverstock and decorative element in a mold; and introducing plastic resin to the mold and forming a substrate. The adhesive may comprise a pressure sensitive adhesive such that the step of introducing plastic resin comprises setting the pressure sensitive adhesive to bond the decorative element to the coverstock. The method may further comprise forming a pocket in the coverstock and substrate around the decorative element.

### BRIEF DESCRIPTION OF THE FIGURES

FIG. 1 is a fragmentary perspective view of a vehicle interior showing a door and an instrument panel.

FIG. 2 is a fragmentary section view of a decorative element applied to a coverstock.

FIG. 3 is a fragmentary section view of a molded article with the decorative element of FIG. 2 recessed in a pocket formed in a substrate.

FIGS. 4 and 5 are exemplary molded articles.

FIG. 6 is a fragmentary side view of a mold and overstock.

FIG. 7 is a fragmentary side view of a mold and coverstock, and injected plastic resin to form the substrate.

FIG. 8 is a fragmentary perspective view of a decorative element applied to a coverstock according to an exemplary embodiment.

FIG. 9 is a fragmentary perspective view of a molded article with the decorative element of FIG. 8 recessed in a pocket formed in a substrate.

### DETAILED DESCRIPTION

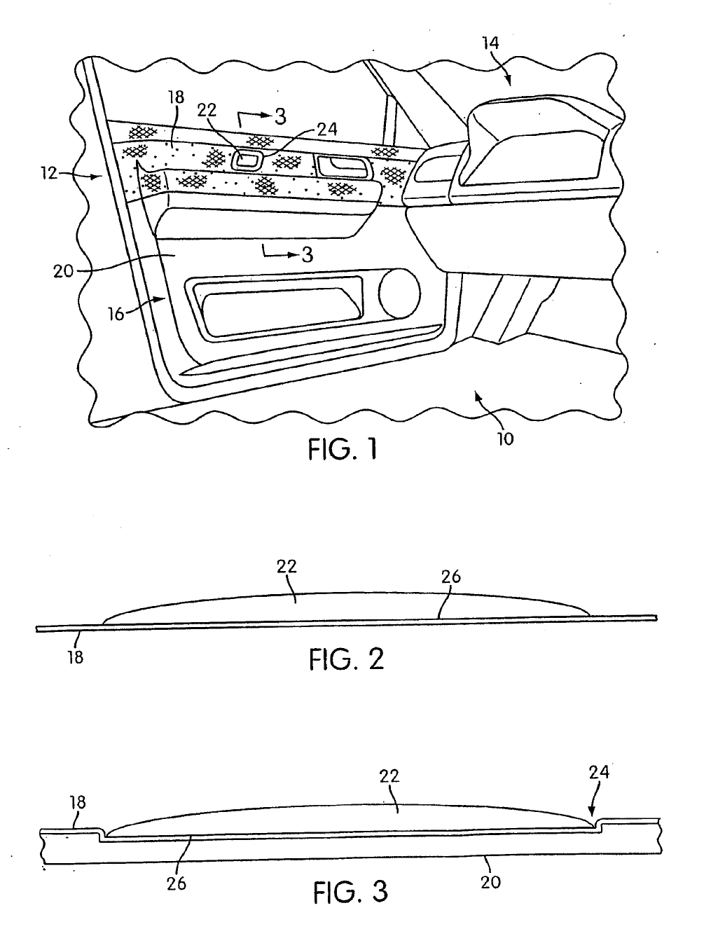

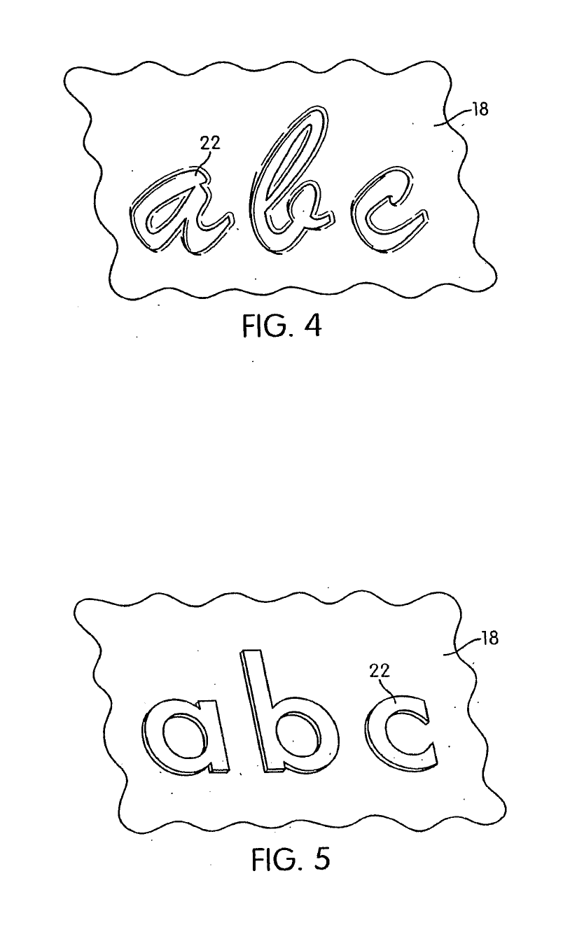

FIG. 1 shows a perspective view of a vehicle interior 10 (e.g., passenger compartment). Interior 10 is shown to include a door 12 and an instrument panel 14. Door 12 and instrument panel 14 each may comprise an outer trim component or panel 16 that is formed by a sheet of material (e.g., flexible member, skin, sheet, foil, coverstock, etc. which will be referred to as coverstock 18) coupled to a base (e.g., rigid member, substrate, etc., which will be referred to as a substrate 20) for structural support. Trim panel 16 also includes a decorative element 22 coupled to coverstock 18 to provide a desired ornamental appearance and/or a functional component. For the purposes of this disclosure, trim panel 16 coupled to door 12 will be further described, but it would be understood by a person having ordinary skill in the art reading this disclosure that the trim panel could be coupled to instrument panel 14, or other surfaces within the vehicle, or used in other applications where a panel with multiple decorative elements is desired.

Coverstock 18 may be made from any of a variety of materials and compositions including fabric (woven, non-woven, etc.) textile, natural, polymer, or the like or combinations thereof; and may have multiple layers (e.g., foam, outer, inner, scrim, etc.).

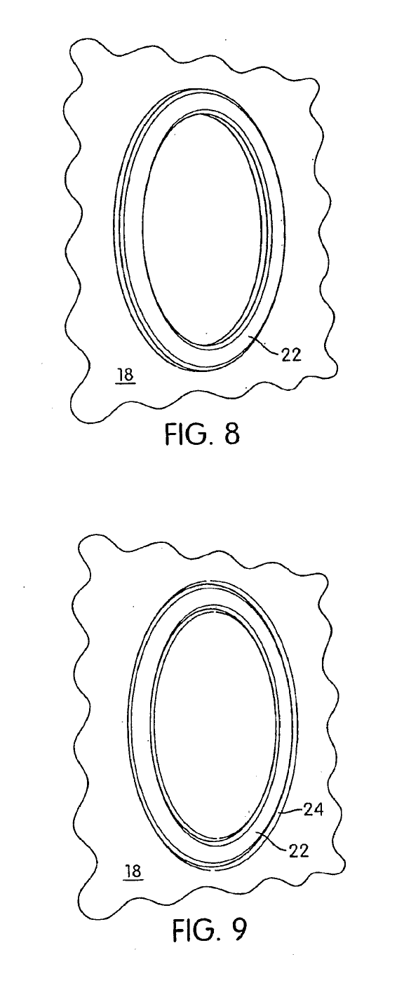

Decorative element 22 is disposed or located in a recess 24 (e.g., pocket, indent, indentation, etc.), and may extend beyond or outside recess 24 relative to the surface of coverstock 18. For example, FIGS. 8 and 9 show a decorative element (emblem) coupled to a coverstock (vinyl) before (FIG. 8) and after (FIG. 9) molding of the substrate. According to an exemplary embodiment, decorative element 22 is coupled to coverstock 18 by an adhesive 26. According to a preferred embodiment, adhesive 26 is a pressure sensitive adhesive that becomes set during the subsequent molding operation (as further explained below). Decorative element 22 may provide any of a variety of ornamental appearances such as colors, textures, patterns, images, indicia, text, designs, or combinations thereof that are formed, added, provided on, printed on, painted on, or otherwise disposed on the side or surface of the coverstock 18 that ultimately at least partially faces the vehicle interior 10 (e.g., the visible surface or the “A-surface”).

According to a preferred embodiment, decorative element 22 comprises flexible and/or compressible materials. According to another embodiment, decorative element 22 comprises an injection molded plastic material. According to yet another embodiment, decorative element 22 comprises a dome coat urethane. According to various other embodiments, the decorative element may be any of a variety of flexible or rigid members intended for disposition on the A-surface of the coverstock.

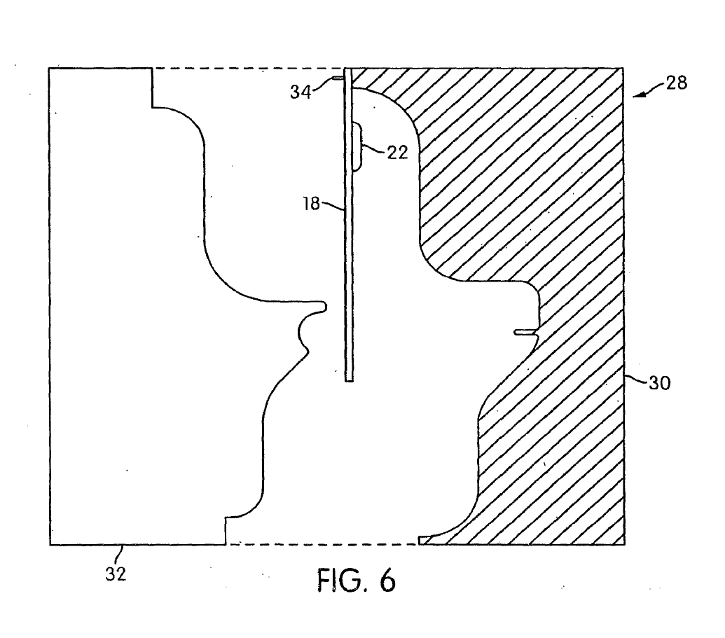

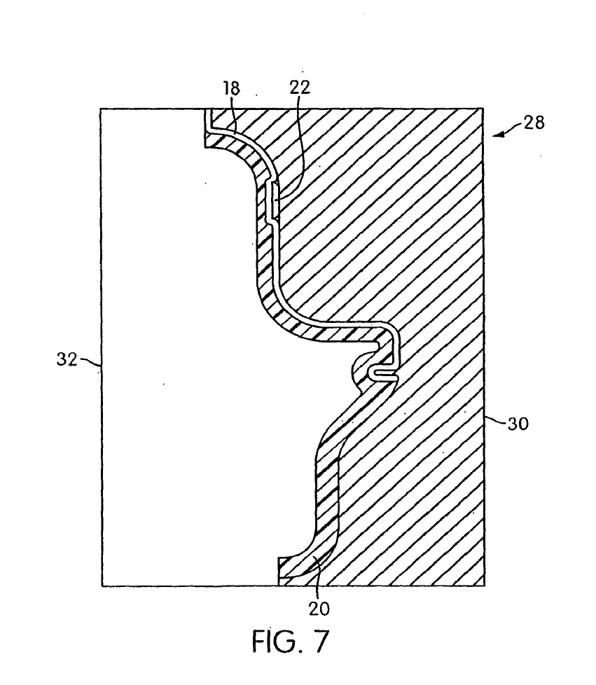

FIGS. 6 and 7 are fragmentary schematic views of a process for forming door trim panel 16 according to an exemplary embodiment. FIG. 6 shows a mold 28 having a first mold section (shown as a cavity 30) and a second mold section (shown as a core 32). Coverstock 18 is positioned between cavity 30 and core 32 when mold 28 is open. According to an exemplary embodiment, coverstock 18 includes apertures that receive projections (e.g., pins 34) extending from cavity 30. In this position, coverstock 18 is suspended (e.g., hangs) from pins 34. Pins 34 are configured to engage recesses in core 32 when the mold 28 closes. Coverstock 18 may be placed in mold 28 by any of a variety of techniques including robotic placement, manual placement, vacuum device, adhesive, or the like. As shown in FIG. 6, coverstock 18 is a generally flat sheet prior to being placed into mold 28. According to a preferred embodiment, the coverstock is thermoformed or otherwise pre-formed into a desired shape and is then placed in the mold and may be held in place by its shape or by pins or the like.

According to a preferred embodiment, decorative element 22 is applied to coverstock 18 before being placed in the molding tool for molding of the substrate 20. Mold 28 closes (or partially closes) around coverstock 18 (e.g., by moving the mold sections toward each other or one of the sections toward the other section) so that a cavity or gap is provided between core 32 and cavity 30. The placement and orientation of coverstock 18 generally follows the contours of the mold sections.

Referring to FIG. 7, molten polymer resin is then injected into the gap between core 32 and coverstock to form substrate 20. As molten plastic resin fills the gap, coverstock 18 is pressed against the surface of core 32 and takes the shape of the surface of core 32 (i.e., the desired final shape of trim panel 16). Coverstock 18 is pressed (i.e., conforms) around decorative element 22 by the pressure of the plastic resin and creates recess 24. Pressure of the injected plastic sets the pressure sensitive adhesive in a strong bond between decorative element 22 and coverstock 18. After the plastic resin has sufficiently solidified, panel 16 is removed from mold 28 upon release of the injection pressure and/or removal from mold 28, decorative element 22 may expand (if made of a compressible material that is compressed during the molding process) and return to its pre-molding thickness. The presence of decorative element 22 in mold 28 during the injection of the plastic resin causes the substrate. 20 to form around the decorative element 22, which creates pockets 24. According to a preferred embodiment, this process may be used with existing mold tools, which makes it adaptable to have some panels molded with the decorative element and other panels molded without the decorative element.

After plastic resin forms substrate 20, the trim panel 16 can undergo any of a variety of finishing operations (e.g., removing any portions of coverstock not attached to substrate (e.g., the portion or strip containing apertures), wrapping around and coupling to the B surface of substrate (e.g., by fasteners, adhesives, welding, heat staking, or the like).

It is to be understood that the invention is not limited to the details of construction and the arrangement of the components set forth in the following description or illustrated in the drawings. The invention is capable of other embodiments or being practiced or carried out in various ways. The molded article described in this disclosure may be employed in a variety of applications, and is generally applicable with any application where it would be beneficial to provide a molded article having two or more areas or portions of different decorative elements that are registered to specific areas of the panel. When the molded article is a trim panel for use in a vehicle, it is suitable for use in an interior passenger compartment of a vehicle, and may find utility in the form of door panels, dashboards, instrument panels, consoles, sidewall trim, overhead liners, sun visors, or other vehicle components or portions thereof. While the disclosed embodiments may be described as a vehicle trim panel, such as a door panel, the features of the disclosed embodiments are equally applicable with other applications such as other panels, molded articles and components and other office, home, or educational, industrial, commercial, or consumer products which employ localized areas or regions of various or different ornamental appearances. It is also to be understood that the phraseology and terminology employed herein is for the purpose of description and should not be regarded as limiting. For example, the terms “substrate,” “coverstock,” and “decorative elements” are intended to be broad terms and not terms of limitation. These components may be used with any of a variety of products or arrangements and are not intended to be limited to use with automotive applications.

In general, the component or molded article described in this disclosure is a molded article having a substrate coupled to a coverstock that has a decorative element coupled to the coverstock. In one embodiment, the molded article is configured as a trim panel for use in a vehicle (e.g., automobiles such as cars, vans, sport utility vehicles, trucks, buses, airplanes, boats, etc.). Providing a trim panel with a coverstock having a decorative element is intended to allow for a wide variety of decorative element possibilities for trim panels on a wide variety of vehicles (e.g., economy, luxury, etc.) in view of manufacturing efficiencies associated with the production of the coverstock and molding the substrate against the coverstock.

Also, the particular materials used to construct the exemplary embodiments are also illustrative For example, injection molded polypropylene is the preferred method and material for making the substrate, but other materials can be used, including other thermoplastic resins such as polyethylene, acrylonitrile butadiene styrene (“ABS”), polyurethane nylon, any of a variety of homopolymer plastics, copolymer plastics, plastics with special additives, filled plastics, etc. Also, other molding operations may be used to form these components, such as injection compression molding, etc. The coverstock is preferably made from vinyl, but can be made from any of a variety of materials and compositions including fabric, cloth, natural material (e.g., leather, etc.), textile (woven, non-woven, knit, etc.), polymer (e.g., thermoplastic elastomer polyolefin (TPO), or materials formed by reaction injection molding (RIM), etc.), elastomer, or the like or combinations thereof; and may have multiple layers (e.g., outer, inner, scrim, etc.).

It is important to note that the construction and arrangement of the elements of the vehicle trim panel as shown in the preferred and other exemplary embodiments is illustrative only. The method may be used for manufacture of any of a variety of trim panels having multiple decorative elements, which may be provided as any of a variety of shapes or configurations on the trim panel. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the [position of elements may be reversed or otherwise varied, and the nature or number of discrete elements or positions may be altered or varied. It should be noted that the elements and/or components of the system may be constructed from any of a wide variety of materials that provide sufficient strength or durability, in any of a wide variety of colors, textures and combinations. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the spirit of the. present inventions as expressed in the appended claims.

1. A molded article for a vehicle interior comprising:
a coverstock configured to provide at least a portion of an A-side of the molded article;
a decorative element coupled to the coverstock by an adhesive; and
a substrate molded behind the coverstock and configured to provide structural support to the coverstock.

2. The molded article of claim 1 wherein the decorative element is compressible.

3. The molded article of claim 1 wherein the decorative element comprises an injection-molded plastic.

4. The molded article of claim 1 wherein the adhesive comprises a pressure sensitive adhesive.

5. The molded article of claim 1 wherein the molded article is a door trim panel.

6. The molded article of claim 1 wherein the coverstock and substrate comprise a recess and the decorative element is located at least partially within the recess.

7. The molded article of claim by 6 wherein the recess substantially conforms to the periphery of the decorative element.

8. The molded article of claim 1 wherein the substrate is injection-molded polypropylene.

9. A method of making a molded article for a vehicle interior comprising:
providing a coverstock and a decorative element;
applying the decorative element to the coverstock with an adhesive;
positioning the coverstock and decorative element in a mold; and
introducing plastic resin to the mold and forming a substrate.

10. The method of claim 9 wherein the adhesive comprises a pressure sensitive adhesive and the step of introducing plastic resin comprises setting the pressure sensitive adhesive to bond the decorative element to the coverstock.

11. The method of claim 9 further comprising forming a pocket in the coverstock and substrate around the decorative element.

12. The method of claim 9, wherein the decorative element comprises an injection-molded plastic.

13. The method of claim 9, wherein the molded article is a door trim panel.

14. The method of claim 9, further comprising thermoforming the coverstock to a desired shape before positioning the coverstock and the decorative element in the mold.

15. A method of making a molded article, comprising:
pre-forming a coverstock in a desired shape;
positioning the coverstock and a decorative element into a mold; and
introducing a plastic resin into the mold, thereby forming a substrate and bonding the decorative element to the coverstock.

16. The method of claim 15, wherein pre-forming the coverstock comprises thermoforming the coverstock.

17. The method of claim 15, further comprising applying the decorative element to the coverstock with an adhesive prior to positioning the coverstock and the decorative element in the mold.

18. The method of claim 17, wherein the adhesive comprises a pressure sensitive adhesive.

19. The method of claim 15, wherein introducing a plastic resin into the mold comprises forming a recess in the coverstock generally conforming to the periphery of the decorative element.

20. The method of claim 15, wherein the decorative element is an injection molded plastic.
